(19) United States
(12) Patent Application Publication
(10) Pub. No.: US 2013/0199077 A1
(43) Pub. Date: Aug. 8, 2013

(54) FISHING SWIVEL SNAP DEVICE

(71) Applicant: Ronnie Tatum, Ripley, MS (US)

(72) Inventor: Ronnie Tatum, Ripley, MS (US)

(21) Appl. No.: 13/368,245

(22) Filed: Feb. 7, 2012

(51) Int. Cl. A01K 97/00

(52) U.S. Cl. 43/4

(57) ABSTRACT

The present invention is a swivel snap device to hold and assist in removing one or more fishing swivel snaps and lures that includes a plastic base with a planar surface, a pair of arms that includes a top arm and a bottom arm with an aperture disposed at each arm's proximal end and a wire spring connector with a pair of extensions and a wire spring that provide a spring-loaded torque force to the extensions. The invention includes a pair of strong metal alloy v-groove ends that includes a v-shaped groove disposed on the v-groove end that are disposed on the distal end of each arm and a top surface that is disposed on the top of the top arm.

### TECHNICAL FIELD & BACKGROUND

For some individuals it may be difficult and painful to use their fingers to open the small device that allows a fishing line to untwist during fishing. It can be time consuming for a person to snap and unsnap hooks and lures when attempting to catch seafood.

The present invention generally relates to a holding and removal assistance device. More specifically, the invention is a holding and removal assistance device that can help open fishing swivel snaps.

It is an object of the invention to provide a swivel snap device that can hold and assist in removing a one or more fishing swivel snaps and lures.

It is an object of the invention to provide a swivel snap device that can open and close a plurality of fishing swivel snaps and lures relatively easily and without a user getting painful finger injuries.

It is an object of the invention to provide a swivel snap device that can be quickly and easily manufactured, packaged and sold.

What is really needed is a swivel snap device that can hold and assist in removing one or more fishing swivel snaps and lures relatively easily and without a user getting painful finger injuries that can be quickly and easily manufactured, packaged and sold.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side perspective view of a swivel snap device, in accordance with one embodiment of the present invention.

FIG. 1B illustrates an overhead perspective view of a base of a swivel snap device, in accordance with one embodiment of the present invention.

FIG. 1C illustrates a front view of a pair of v-groove ends of a swivel snap device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

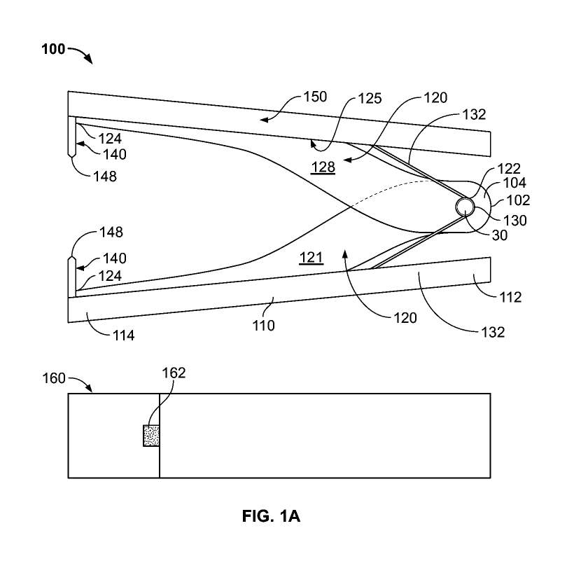

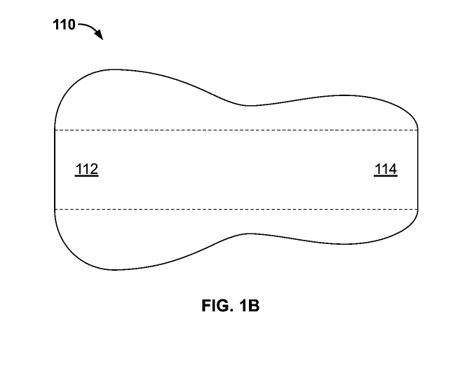

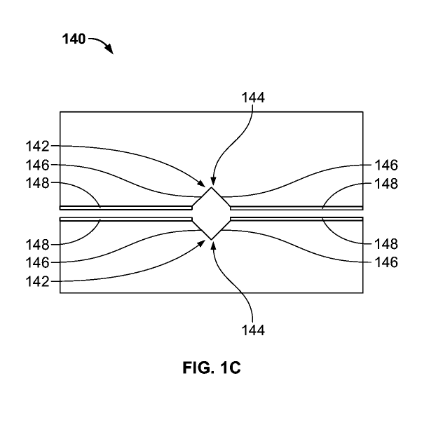

FIG. 1A illustrates a side perspective view of a swivel snap device 100, in accordance with one embodiment of the present invention. The swivel snap device 100 includes a base 110, a pair of arms 120, a wire spring connector 130, a pair of v-shaped groove ends 140 and a top surface 150. The swivel snap device 100 can hold and assist in removing one or more fishing swivel snaps and lures relatively easily and without a user getting painful finger injuries that can be quickly and easily manufactured, packaged and sold.

The base 110 is a planar surface that has a proximal end 112 and a distal end 114. The base 110 is broadened at the proximal end 112 and its distal end 114 to provide further support and stability to the swivel snaps device 100. The base 110 is made of plastic material although the base 110 can be made of other suitable materials as well. The pair of arms 120 also each has a proximal end 122 and a distal end 124. The arms 120 each have an aperture 126 at each proximal end 122. The arms 120 are attached at each proximal end 122. The top arm 128 of the pair of arms 120 can have pressure applied to bring the top arm 128 and distal end 124 towards the bottom arm 121 and distal end 124 making contact with a fishing swivel snap (not shown). The wire spring connector 130 has a pair of extensions 132 and a wire spring 134. The extensions 132 are integral to the wire spring 134 and provide a spring-loaded torque force to the extensions 132. The extensions 132 are incorporated into the arms 120 with each individual extension 132 being incorporated into each individual arm 120. The wire spring connector 130 is disposed in each aperture 126 at each proximal end 122 of the arms 120 while the extensions 132 are incorporated into each arm 120. The wire spring connector 130, extensions 132 and a wire spring 134 are made of stainless steel although the wire spring connector 130 and its components can be made of other suitable materials as well.

The pair of v-groove ends 140 include a v-shaped groove 142 disposed on the middle 144 of the v-groove end 140 and a pair of cutting surfaces 146 that hold the v-groove end 140 together. The each end of the pair of v-groove ends 140 is disposed on each distal end 124 of each individual arm 120. The v-grooved ends 140 are depressed together onto a fishing swivel snap that secure the fishing swivel snap while the fishing swivel snap is separated. The v-grooved ends 140 can secure a barrel swivel safety type of fishing swivel snap and a barrel swivel interlock type of fishing swivel snap. Although the swivel snap device 100 and the v-grooved ends 140 are typically utilized to release fishing swivel snaps, the swivel snap device 100 and the v-grooved ends 140 can be utilized to release other suitable types of swivel snaps. The v-shaped groove 142 will be only as wide as the swivel snaps desired to be opened and closed and the depth of the v shaped-groove 142 will only be as deep as the thickness of the swivel snap to be opened and closed. The v-grooved ends 140 are made of a relatively strong metal alloy although the v-grooved ends 140 can be made of other suitable material. The top surface 150 is disposed on top 125 of the top arm 128 of the pair of arms 120. The top surface 150 covers the entire top 125 of the top arm 128 and serves as the outer surface of the top arm 128.

The swivel snap device 100 is relatively lightweight and is waterproof. The swivel snap device 100 is shaped similar to a small staple remover and is approximately 2 to 3 inches long and ½ inch wide or less. The swivel snap device 100 will come in a plurality of different colors and can optionally have an aperture 102 on its back end 104 for relatively easy carrying on an exterior rope or chain. The swivel snap device 100 can also optionally include a holster 160 to carry the swivel snap device 100 on a rod-n-reel or other suitable device. The holster 160 will have a hook and loop fastener 162 to attach the swivel snap device 100 to a rod and reel or other suitable device.

FIG. 1B illustrates an overhead perspective view of a base 110 of a swivel snap device 100, in accordance with one embodiment of the present invention.

The base 110 is broadened at the proximal end 112 and its distal end 114 to provide further support and stability to the swivel snaps device 100.

FIG. 1C illustrates a front view of a pair of v-groove ends 140 of a swivel snap device 100, in accordance with one embodiment of the present invention.

As previously described and illustrated in FIG. 1A and its description, the pair of v-groove ends 140 includes a v-shaped groove 142. The pair of cutting surfaces 146 is the two sides that form the v-shaped groove 142. The v-shaped groove 142 and the pair of cutting surfaces 146 hold the v-groove ends 140 during the cutting process. The cutting blades 148 that can be utilized as a fishing line cutter or other suitable cutter.

The swivel snap device is a gadget which holds hooks directly. The swivel snap device is relatively small and compact at approximately 3 inches long and ½ inches wide, made of plastic, with teeth made of a metal alloy with a v-shape groove on the bottom intended to grasp a swivel snap when operated. The swivel snap device is a lightweight product that comes equipped with a wire spring for a quick, continuous return to open the snaps. Among users who will find the swivel snap device convenient and easy to use are people who enjoy fishing.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A swivel snap device to hold and assist in removing one or more fishing swivel snaps and lures, comprising:
a base with a planar surface that has a proximal end and a distal end;
a pair of arms that includes a top arm with a top and a bottom arm with each said arm having a proximal end and a distal end with an aperture disposed at each said proximal end;
a wire spring connector with a pair of extensions and a wire spring wherein said extensions are integral to said wire spring and provide a spring-loaded torque force to said extensions wherein said wire spring connector is disposed in each said aperture at each said proximal end of said arms;
a pair of v-groove ends with a middle that includes a v-shaped groove disposed on said middle of said v-groove end that are disposed on said distal end of each said arm; and
a top surface that is disposed on said top of said top arm.

2. The device according to claim 1, wherein said base is broadened at said proximal end and said distal end to provide additional support and stability to said swivel snap device.

3. The device according to claim 1, wherein said top arm is applied with pressure to bring said top arm and said distal end towards said bottom arm and said distal end making contact with said fishing swivel snap.

4. The device according to claim 1, wherein said extensions are incorporated into said arms with each individual said extension incorporated into each individual said arm.

5. The device according to claim 1, wherein said v-groove ends are depressed together onto said fishing swivel snap to secure said fishing swivel snap while said fishing swivel snap is separated.

6. The device according to claim 1, wherein said top surface serves as an outer surface of said top arm.

7. A swivel snap device with a back end to hold and assist in removing one or more fishing swivel snaps and lures, comprising:
a plastic base with a planar surface that has a proximal end and a distal end;
a pair of arms that includes a top arm with a top and a bottom arm with each said arm having a proximal end and a distal end with an aperture disposed at each said proximal end;
a wire spring connector with a pair of extensions and a wire spring wherein said extensions are integral to said wire spring and provide a spring-loaded torque force to said extensions wherein said wire spring connector is disposed in each said aperture at each said proximal end of said arms;
a pair of strong metal alloy v-groove ends with a middle that includes a v-shaped groove disposed on said middle of said v-groove end that are disposed on said distal end of each said arm;
a top surface that is disposed on said top of said top arm; and
an aperture on said back end of said device to carry said device on an exterior rope or chain.

8. The device according to claim 7, wherein said base is broadened at said proximal end and said distal end to provide additional support and stability to said swivel snaps device.

9. The device according to claim 7, wherein said top arm is applied with pressure to bring said top arm and said distal end towards said bottom arm and said distal end making contact with said fishing swivel snap.

10. The device according to claim 7, wherein said extensions are incorporated into said arms with each individual said extension incorporated into each individual said arm.

11. The device according to claim 7, wherein said v-groove ends are depressed together onto said fishing swivel snap to secure said fishing swivel snap while said fishing swivel snap is separated.

12. The device according to claim 7, wherein said top surface serves as an outer surface of said top arm.

13. The device according to claim 7, wherein said fishing swivel snaps and lures include a barrel swivel safety type of fishing swivel snap.

14. A swivel snap device to hold and assist in removing one or more fishing swivel snaps and lures, comprising:
a plastic base with a planar surface that has a proximal end and a distal end;
a pair of arms that includes a top arm with a top and a bottom arm with each said arm having a proximal end and a distal end with an aperture disposed at each said proximal end;
a stainless steel wire spring connector with a pair of extensions and a wire spring wherein said extensions are integral to said wire spring and provide a spring-loaded torque force to said extensions wherein said wire spring connector is disposed in each said aperture at each said proximal end of said arms;
a pair of strong metal alloy v-groove ends with a middle that includes a v-shaped groove disposed on said middle of said v-groove end that are disposed on said distal end of each said arm;
a top surface that serves as an outer surface of said top arm that is disposed on said top of said top arm;
an aperture on said back end of said device to carry said device on an exterior rope or chain; and
a holster to carry said swivel snap device.

15. The device according to claim 14, wherein said base is broadened at said proximal end and said distal end to provide additional support and stability to said swivel snap device.

16. The device according to claim 14, wherein said top arm is applied with pressure to bring said top arm and said distal end towards said bottom arm and said distal end making contact with said fishing swivel snap.

17. The device according to claim 14, wherein said extensions are incorporated into said arms with each individual said extension incorporated into each individual said arm.

18. The device according to claim 14, wherein said v-groove ends are depressed together onto said fishing swivel snap to secure said fishing swivel snap while said fishing swivel snap is separated.

19. The device according to claim 14, wherein said v-groove ends are a pair of cutting blades that serve as a fishing line cutter.

20. The device according to claim 14, wherein said fishing swivel snaps and lures include a barrel swivel safety type of fishing swivel snap and a barrel swivel interlock type of fishing swivel snap.
